(19) United States
(12) Patent Application Publication
(10) Pub. No.: US 2006/0113352 A1
(43) Pub. Date: Jun. 1, 2006

(54) Grips for handheld power tool

(75) Inventors: Billy Liu, Kowloon Bay (HK); Kevin O'Doherty, Kowloon Bay (HK); Jeff Campbell, Bellevue, WA (US); John Lu, Renton, WA (US); Russell Borgmann, Bellevue, WA (US); Grigore Axinte, Kent, WA (US)

Correspondence Address: WILMER CUTLER PICKERING HALE AND DORR LLP, THE WILLARD OFFICE BUILDING, 1455 PENNSYLVANIA AVE, NW, WASHINGTON, DC, 20004, US

(73) Assignee: Hyperion Innovations, Inc., Bellevue, WA (US)

(21) Appl. No.: 11/248,219

(22) Filed: Oct. 13, 2005

Related U.S. Application Data
(60) Provisional application No. 60/618,945, filed on Oct. 13, 2004.
(60) Provisional application No. 60/626,505, filed on Nov. 8, 2004.

(51) Int. Cl. B23K 3/02

(52) U.S. Cl. 228/51

(57) ABSTRACT

A handheld power tool, such as a soldering tool, is provided with grip pads. These grip pads increase the friction between a user's fingers and the power tool, in order to increase control when using the tool. These grip pads are especially useful in tools which are held in a pen like grip.

### CROSS-REFERENCES TO RELATED APPLICATIONS

This application claims the benefit of U.S. Provisional Patent Nos. 60/618,945, filed Oct. 13, 2004, and 60/626,505, filed Nov. 8, 2004. These applications are incorporated by reference in their entirety.

### FIELD OF THE INVENTION

The present invention generally relates to power tools and more specifically to grips for power tools.

### BACKGROUND OF THE INVENTION

Soldering tools are often used when it is required to make manual electrical conductive connections between various electrical components. Soldering tools are used for a variety of applications, such as the repair of printed circuit boards in many different industries, such as in telecommunications or computer manufacturing or repair. Known soldering tools vary by power source, application, performance, shape, size, temperature, tip type, heat source, price, and/or portability.

Various soldering tools exist today, including both corded and cordless soldering tools. Corded soldering tools use a power cord to deliver alternating current (AC) power to the soldering tool from a common household outlet. For a corded soldering tool, a stepdown transformer converts the power supplied to the soldering tool from AC to direct current (DC) for heating the electrode(s) at the soldering tool tip. There are many types of cordless power tools, such as drills, screwdrivers, nail guns, and saws. Cordless power tools are generally portable for enabling tool operation at job sites where AC power may not be easily accessible.

Soldering components, like integrated circuits, onto printed circuit boards takes a great deal of precision, and can require the soldering of many small leads together. Each connection is critical to the proper operation of the device, because an integrated circuit with even one incorrectly soldered lead can fail to perform correctly. Therefore, the accurate soldering of many leads is an important task in the manufacturing and repair of electrical devices. Leads that are incorrectly soldered must be fixed, but correcting mistakes is a time consuming process. Fixing connections generally requires re-heating the connection and then attempting to remove or add the correct amount solder. This process must be repeated until the desired results are achieved.

The present invention generally relates to incorporating a high friction material on a power tool to improve a user's control in handling and maneuvering the tool between a user's fingers during operation of the tool.

### SUMMARY

A grip is disclosed for a power tool that is held during use between the thumb and at least the index finger. The grip increases a user's control of the tool by increasing the friction between a user's fingers and the tool. In an alternative embodiment, the grip is compressible and may slightly and temporarily mold to the shape of a user's fingers to further increase user control and comfort during use of the tool. The increased control reduces the chance that the tool will slip from a user's grip, and therefore reduces the number of mistakes that need to be corrected later. This saves the user time and effort.

Accordingly, a power tool assembly is described that is adapted to be held during use with a pen-like grip. The assembly comprises a housing comprised of at least a first material. One or more grip pads are affixed to the housing, the grip pads comprised of a second material different from the first material. The second material has a higher coefficient of friction than the first material. In at least one embodiment, the power tool has a housing adapted to be held during use between the thumb and at least the index finger of one hand.

### BRIEF DESCRIPTION OF THE DRAWINGS

The foregoing aspects and many of the attendant advantages of this invention will become more readily appreciated by reference to the following detailed description, when taken in conjunction with the accompanying drawing, wherein:

FIG. 1 is an isometric view of a soldering tool with grips pads in accordance with one embodiment of the present invention.

### DETAILED DESCRIPTION

The present invention will now be described with reference to the disclosed drawing. Embodiments of the present invention are directed to power tools generally. The following descriptions and illustrations herein should be considered illustrative in nature, and thus, not limiting the scope of the present invention as claimed.

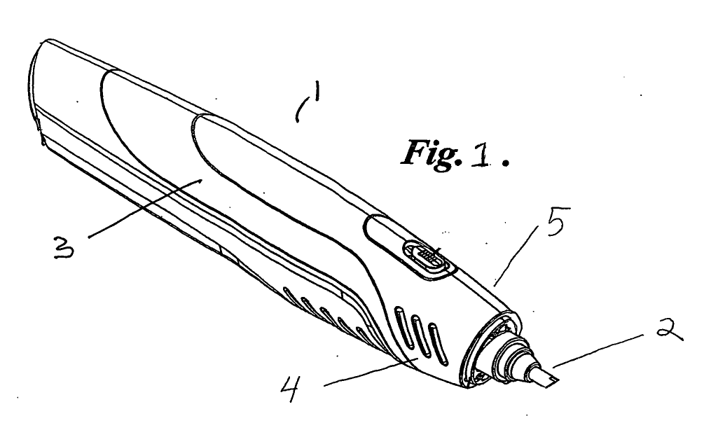

Referring to FIG. 1, one embodiment of a cordless soldering tool 1 formed in accordance with the disclosure of the present invention is illustrated. The soldering tool 1 includes a tip 2 attached to a body or housing 3. The body is generally made out of a hard material such as metal or stiff plastic. The soldering tool 1 is powered by batteries (not shown) and thus operates without a cord. Because the soldering tool 1 has no cord, it is very portable. The portability of this soldering tool 1 allows for use in many different environments, such as a job site where AC power is not conveniently accessible, on a ladder, or in other areas with difficult accessibility to AC power. Instead of AC power, power is supplied to the cordless soldering tool from batteries contained within the body of the tool.

The body or housing of the soldering tool can be shaped in various ways; however, the substantially tubular shape shown in FIG. 1 is narrow enough that it can be held between a user's thumb and index finger in a pen-like grip.

To increase control, grip pads 4 and 5 are added near the front of the tool. The front of a soldering tool is where the tip is located, and where the actual process of soldering occurs. Generally, the front for other power tools will be where the function of the tool is being performed. Grip pad 5 (not shown) is on the other side of the soldering tool directly opposite to grip pad 4. Working together, these pads engage a user's fingers when the soldering tool is held in a pen-like grip. The pads can be either raised above the surface of the body of the tool, or they can be built into the body and appear flush with the rest of the surface of the tool.

A pen-like grip involves a user's thumb contacting one grip pad, and at least the user's index finger contacting another grip pad on the opposite side of the tool. Depending on the weight and size of the tool, as well as a user's preferences, additional fingers may also contact the grip pad opposite the thumb. Further, a pen-like grip involves not only holding the tool between the thumb and at least the index finger, but also tilting the tool such that one end is pointed towards the user's palm, and optionally rested on the side of the hand between the thumb and index finger.

The grip pads can be made out of a material that is different than the body of the tool, and one that increases the friction between the user's fingers and the body of the tool. Additionally, the material of the grip pads can be a compressible material, such as rubber, so that when a user presses his fingers against the pads, they conform to a user's fingers at least slightly, further increasing control when compared to a material that only increases friction.

One example embodiment of the grip pads includes a row of three raised strips on both sides of a soldering tool. These three strips are separated to cover an area sufficient to engage a user's thumb on one side, and to engage one or more fingers on the other side of the tool. They also allow a user to place their fingers either closer or further from the front of the tool depending on their preferences.

The invention is not limited to the various embodiments described above, and there are many alternatives that would serve the same function as the grip pads shown. The pads could instead be many small bumps of a high-friction material, one large oval, or any shape or shapes that cover enough area to properly engage and user's thumb and fingers. The grip pads could even cover a substantial portion of the body of the tool, or fit like a sleeve over the entire front of it, as long as there is a sufficient amount of contact area to engage a user's thumbs and fingers.

Further, the invention is not limited to the use of grip pads on solder tools. The pads can be incorporated into any power tool that, when in use, is controlled, maneuvered or otherwise held between a user's thumb and index finger.

What is claimed is:

1. A power tool assembly adapted to be held during use with a pen-like grip, comprising:
a housing comprised of at least a first material; and
one or more grip pads affixed to the housing, the grip pads comprised of a second material different from the first material, wherein the second material has a higher coefficient of friction than the first material.

2. The power tool assembly of claim 1, wherein the grip pads are located near the front of the power tool.

3. The power tool assembly of claim 2, wherein the grip pads are comprised of a compressible material.

4. The power tool assembly of claim 3, wherein the power tool is a soldering tool.

5. The power tool assembly of claim 4, wherein the soldering tool is cordless.

6. A power tool assembly comprising:
a power tool having a housing adapted to be held during use between a thumb and at least index finger of one hand, the housing substantially comprised of a first material; and one or more grip pads affixed to the power tool and positioned to contact the thumb and at least the index finger of a user's hand during use of the power tool;
wherein the grip pads are comprised of a second material having a higher coefficient of friction than the first material substantially comprising the housing.

7. The power tool assembly of claim 6, wherein the grips pads are located near the front of the power tool.

8. The power tool assembly of claim 7, wherein the grip pads are made of a compressible material.

9. The power tool assembly of claim 8, wherein the grip pads are flush with the surface of the housing of the power tool.

10. The power tool assembly of claim 8, wherein the second material is rubber.

11. The power tool assembly of claim 8, wherein the first material is plastic.

12. The power tool assembly of claim 8, wherein the power tool rests on the side of the hand between a person's thumb and index finger.

13. The power tool assembly of claim 8, wherein the power tool is a cordless soldering tool.

14. The power tool assembly of claim 13, wherein the cordless soldering tool is powered by electrical charge.

15. The power tool assembly of claim 14, wherein the electrical charge is provided by batteries.

16. The power tool assembly of claim 8, wherein the housing is substantially tubular.
